(19) United States
(12) Patent Application Publication
(10) Pub. No.: US 2013/0076310 A1
(43) Pub. Date: Mar. 28, 2013

(54) BALANCING SYSTEM FOR POWER BATTERY AND CORRESPONDING LOAD BALANCING METHOD

(71) Applicants: Laurent Garnier, Marennes (FR); Daniel Chatroux, Teche (FR); Matthieu Desbois-Renaudin, Villard de Lans (FR)

(72) Inventors: Laurent Garnier, Marennes (FR); Daniel Chatroux, Teche (FR); Matthieu Desbois-Renaudin, Villard de Lans (FR)

(73) Assignee: Commissariat a l'energie atomique et aux energies alternatives, Paris (FR)

(21) Appl. No.: 13/696,210

(22) PCT Filed: May 4, 2011
(86) PCT No.: PCT/EP2011/057165

§ 371 Date: Nov. 21, 2012

(30) Foreign Application Priority Data
May 5, 2010 (FR) 1053516
Mar. 9, 2011 (FR) 1151924

(51) Int. Cl. H02J 7/00

(52) U.S. Cl. CPC H02J 7/0019
USPC 320/118

(57) ABSTRACT

A charge-balancing system for a power battery includes series accumulator stages, each having accumulator, and flyback converter. The converter has a transformer with a primary configured to be connected to terminals of an accumulator stage of the power battery, and a secondary configured to connect to an auxiliary battery. Each accumulator stage has a switch connected to the primary and to a negative terminal of the accumulator stage. The system also has a monitoring device for monitoring voltage across terminals of the accumulator stages, and a control device for controlling the converter by receiving voltage information from the monitoring device. When an accumulator stage's voltage exceeds that of other accumulator stages, the controller closes the associated switch and transfersg energy from the accumulator stage to the auxiliary battery so as to balance charge of said accumulator stages.

The invention relates to a charge balancing system for electrochemical accumulator power battery and a corresponding charge balancing method.

Such a battery may be used especially in the field of electric transport, hybrid transport and onboard systems. The invention relates in particular to batteries of lithium-ion (Li-ion) type adapted for applications of this kind, on account of their possibility of storing considerable energy with a low mass. The invention is also applicable to super-capacitors.

An electrochemical accumulator has a nominal voltage of the order of a few volts, and more precisely 3.3 V for Li-ion batteries based on Iron phosphate and 4.2 V for an Li-ion technology based on cobalt oxide. If this voltage is too low with respect to the requirements of the system to be energized, several accumulators are arranged in series. It is also possible to dispose in parallel with each accumulator associated in series, one or more accumulators so as to increase the available capacitance and therefore to provide higher current and higher power. The accumulators associated in parallel thus form a stage. A stage consists of a minimum of one accumulator. The stages are arranged in series so as to attain the desired voltage level. The association of the accumulators is called an accumulator battery.

The charging or discharging of an accumulator is manifested respectively by a growth or decay of the voltage across its terminals.

An accumulator is considered charged or discharged when it has attained a voltage level defined by the electrochemical process. In a circuit using several accumulator stages, the current flowing through the stages is the same.

The level of charge or of discharge of the stages therefore depends on the intrinsic characteristics of the accumulators, namely the intrinsic capacitance and the series and parallel stray internal resistances, of the electrolyte or of contact between the electrodes and the electrolyte. Voltage differences between the stages are therefore possible on account of the disparities of manufacture and of aging of the accumulators.

For an Li-ion technology accumulator, too high or too low a voltage, termed the threshold voltage, may damage or destroy the accumulator. For example, overcharging an Li-ion accumulator based on cobalt oxide may cause thermal runaway thereof and start a fire. For a phosphate-based Li-ion accumulator, overcharging is manifested by decomposition of the electrolyte which decreases its lifetime or may impair the accumulator.

Too deep a discharge which leads to a voltage of less than 2 V, for example, leads among other things to oxidation of the negative electrode's current collector when the latter is made of copper and therefore impairment of the accumulator.

Consequently, monitoring of the voltages across the terminals of each accumulator stage is compulsory during charging and discharging for the sake of safety and reliability. A so-called monitoring device in parallel with each stage makes it possible to ensure this function.

The function of the monitoring device is to follow the state of charge and of discharge of each accumulator stage and to transmit the information to a drive circuit so as to stop the charging or discharging of the battery when a stage has attained its threshold voltage.

However, on a battery with several accumulator stages disposed in series, if charging is stopped when the most charged stage attains its threshold voltage, the other stages may not be fully charged. Conversely, if discharging is stopped when the most discharged stage attains its threshold voltage, the other stages may not be fully discharged. The charge of each accumulator stage is therefore not utilized, this representing a major problem in applications of transport and onboard types having strong autonomy constraints. To alleviate this problem, the monitoring device is generally associated with a balancing system.

The function of the balancing system is to optimize the charge of the battery and therefore its autonomy by bringing the accumulator stages arranged in series to an identical state of charge and/or discharge.

There exist two categories of balancing systems, so-called energy dissipation balancing systems, or so-called energy transfer balancing systems.

With energy dissipation balancing devices, the voltage across the terminals of the stages is equilibrated by rerouting the charge current of one or more stages that have attained the threshold voltage and by dissipating the energy in a resistor. As a variant, the voltage across the terminals of the stages is equilibrated by discharging one or more stages that have attained the threshold voltage.

However, such energy dissipation balancing systems exhibit the major drawback of consuming more energy than required to charge the battery. Indeed, it is necessary to discharge several accumulators or to divert the charge current of several accumulators so that the last accumulator or accumulators, which are slightly less charged, terminate their charging. The energy dissipated may therefore be much greater than the energy of the charging or chargings that has or have to be terminated. Moreover, they dissipate the excess energy as heat, this not being compatible with the constraints of integration within applications of transport and onboard types, and the fact that the lifetime of the accumulators diminishes greatly when the temperature rises.

For their part, energy transfer balancing systems exchange energy between the accumulator battery or an auxiliary energy network and the accumulator stages.

The energy transfer may be performed either in a unidirectional manner, from the battery to the stages or from the stages to the battery, or else in a bidirectional manner, from the battery to the stages and from the stages to the battery or from adjacent stage to stage.

As regards bidirectional transfer, in adjacent stage to stage balancing systems, the energy traverses a number of devices which is substantially equal to the remoteness of the cells to be balanced. This results in the two major drawbacks of these devices, namely the necessity for a long time in which to balance a battery and the low efficiency of the energy transfer because of the aggregation of the losses of the devices invoked.

Balancing systems transferring energy from the stages to the battery and/or from the battery to stages make it possible to solve these problems. However, for reasons of complexity of implementation, such systems are hardly if at all used.

As regards unidirectional transfer, patent CN1905259 discloses a device allowing the transfer of energy from the stages to the battery and which, for its part, uses one inductor per accumulator as storage element. However, this device does not opt for energy transfer that is optimized for the balancing of the batteries in applications of transport and onboard types. Indeed, the end of charging of a battery is determined by the last stage which attains the threshold voltage. To terminate the charging of a battery, the energy is tapped off from one or more stage(s) and it is fed back to all the stages. When one or more accumulator stage(s) is or are slightly less charged, the energy is therefore not transferred by priority to the stage(s) which need it but also to the stages from which the energy is tapped off. Balancing therefore requires that energy be tapped off from all the stages at the end of charging so as to avoid charging them to too high a voltage. The balancing is therefore done with high losses on account of the number of sizable converters in operation. Moreover, the accumulators already at the end of charging are traversed by non-useful AC or DC components of current.

The objective of the invention is therefore to propose an improved balancing system not exhibiting these drawbacks of the prior state of the art.

For this purpose, the subject of the invention is a charge balancing system for power battery comprising at least two accumulator(s) stages arranged in series, each accumulator(s) stage comprising at least one accumulator, characterized in that said balancing system comprises at least one flyback converter comprising:
a transformer with:
   at least one primary winding configured to be connected to the terminals of an accumulator(s) stage of said power battery, and
   a secondary winding configured to be connected to an auxiliary battery whose voltage is less than the voltage of said power battery, and
for each accumulator(s) stage, an associated switch connected to a primary winding of said transformer and to the negative terminal of the accumulator(s) stage, and in that said system furthermore comprises:
a monitoring device for the voltage across the terminals of said accumulator(s) stages, and
a control device for said flyback converter comprising at least one processing means for:
   receiving the voltage information of said monitoring device, and
   when at least one stage exhibits a voltage greater than the voltage of the other accumulator(s) stages, commanding the closure of at least one switch associated with an accumulator(s) stage and the transfer of energy from said stage to said auxiliary battery, so as to balance the charge of the accumulator stages.

Said balancing system can furthermore comprise one or more of the following characteristics, alone or in combination:
said system comprises a predefined number of flyback converters respectively associated with a predefined number of modules in series of said power battery, said modules comprising accumulator(s) stages arranged in series,
said system comprises a common flyback converter connected to a predefined number of modules in series of said power battery, said modules comprising accumulator(s) stages arranged in series,
said system comprises for each accumulator(s) stage, a blocking diode linked by its anode to the primary winding of the transformer, and linked by its cathode to the associated switch,
the blocking diode is a Schottky diode,
said system comprises for each accumulator(s) stage a diode and a transistor in parallel, such that the diode is linked by its anode to the primary winding of the transformer and linked by its cathode to the associated switch of the accumulator(s) stage,
the switches of said at least one flyback converter are controlled in a common manner by said control device so as to be closed at the same time when at least one accumulator(s) stage exhibits a voltage greater than the respective voltages of the other accumulator(s) stages,
the switches of said at least one flyback converter are controlled in an individual manner by said control device, so as to command the closure of the switch associated with an accumulator(s) stage whose voltage is greater than the respective voltages of the other accumulator(s) stages,
said control device comprises at least one processing means for
   calculating for each accumulator stage, a closure time for the associated switch on the basis of the determined degree of charge, and
   commanding the closure of the switches respectively during the associated closure times,
said at least one flyback converter is dimensioned for a transfer of energy from the power battery to the auxiliary battery so as to energize the auxiliary battery,
said system is configured for the charge balancing of the accumulator(s) stages of a Lithium-ion power battery,
said system is configured for the charge balancing of the accumulator(s) stages of a power battery energizing the motor of an electric and/or hybrid automotive vehicle.

Said balancing system can moreover furthermore comprise one or more of the following characteristics, alone or in combination:
said balancing system comprises at the terminals of each accumulator(s) stage
   an associated flyback converter comprising a transformer with: a primary winding configured to be connected to the terminals of said associated accumulator(s) stage, and a secondary winding configured to be connected to an auxiliary network whose voltage is less than the voltage of said power battery, and for each accumulator(s) stage, an associated switch connected to a primary winding of said transformer and to the negative terminal of the accumulator(s) stage, and said system furthermore comprises:
   a monitoring device for the voltage across the terminals of said accumulator (s) stages, and
   a control device for said flyback converters comprising respectively at least one processing means for: receiving the voltage information of said monitoring device, and when at least one stage exhibits a voltage greater than the voltage of the other accumulator(s) stages, commanding the closure of at least one switch of a flyback converter associated with an accumulator(s) stage and the transfer of energy from said stage to the auxiliary network, so as to balance the charge of the accumulator stages;
said transformer is a planar technology transformer,
said system comprises a plurality of diodes respectively mounted in series with said transformers, said diodes being respectively connected by their anode to the secondary winding of a transformer and by their cathode to said auxiliary network;
said control device is configured to control said converters so as to transfer the balancing energy from said stages to said auxiliary network, and said flyback converters exhibit galvanic isolation,
said control device is configured to control said converters so as to transfer the balancing energy from said stages to an auxiliary battery whose voltage is less than the voltage of said power battery,
said switches are controlled in an individual manner,
said control device is configured to command the closure of the switch associated with an accumulator(s) stage whose voltage is greater than the respective voltages of the other accumulator(s) stages,
said control device comprises at least one processing means for calculating for each accumulator stage, a closure time for the associated switch, and commanding the closure of the switches respectively during the associated closure times,
said control device is configured to control said converters so as to energize said auxiliary network on the basis of the balancing energy for said power battery,
said control device comprises at least one processing means for determining the power to be delivered respectively by said stages.

The invention also relates to a charge balancing method for power battery comprising at least two accumulator(s) stages arranged in series, each accumulator(s) stage comprising at least one accumulator, characterized in that said method comprises the following steps:
the voltage is measured across the terminals of each accumulator(s) stage,
the measured voltages are compared, and
when one measured voltage is greater than the other measured voltages, the closure is commanded of at least one switch of a flyback converter whose transformer exhibits at least one primary winding connected to the terminals of an accumulator(s) stage of said power battery and linked to said switch, and a secondary winding connected to an auxiliary battery whose voltage is less than the voltage of said power battery, for a transfer of energy from said stage associated with said at least one switch whose closure is commanded to said auxiliary battery, so as to balance the charge of the accumulator stages.

According to a preferred embodiment such a method is a combined method of charge balancing for power battery and of energizing of an auxiliary battery whose voltage is less than the voltage of said power battery.

According to one embodiment, said method comprises the following steps:
for each accumulator(s) stage, a closure time is calculated for the associated switch of a flyback converter whose transformer exhibits a primary winding connected to the terminals of the accumulator(s) stage and linked to said switch, and a secondary winding connected to the auxiliary battery, and
the closure of the switches is commanded respectively during the calculated closure times.

Said charge balancing method can comprise the following preliminary steps:
the voltage is measured across the terminals of each accumulator(s) stage of said power battery,
the measured voltages are compared with a predefined threshold voltage,
the degree of charge of each accumulator(s) stage is determined on the basis of the comparison results, making it possible to calculate the closure time.

According to an alternative, said charge balancing method can comprise the following preliminary steps:
the voltage is measured across the terminals of each accumulator(s) stage of said power battery,
the measured voltages are compared with each other, and
the most charged accumulator(s) stages are determined so as to calculate longer closure times for the more charged accumulator(s) stages.

According to a particular embodiment, the voltages are measured across the terminals of the accumulator(s) stages at a predefined instant, such as the end of the charging of said power battery. dr

Other characteristics and advantages of the invention will emerge from the following description, given by way of example, without limiting character, with regard to the appended drawings in which:

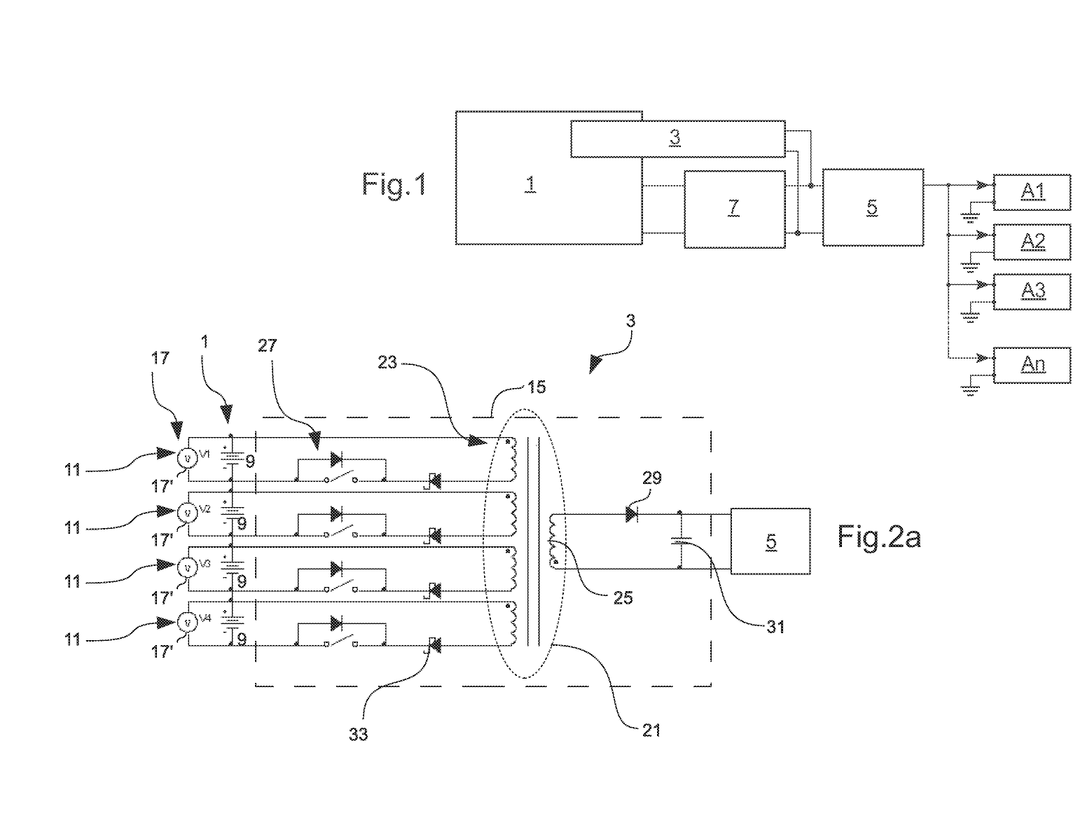

FIG. 1 represents in a schematic manner a first embodiment of a power battery balancing system,

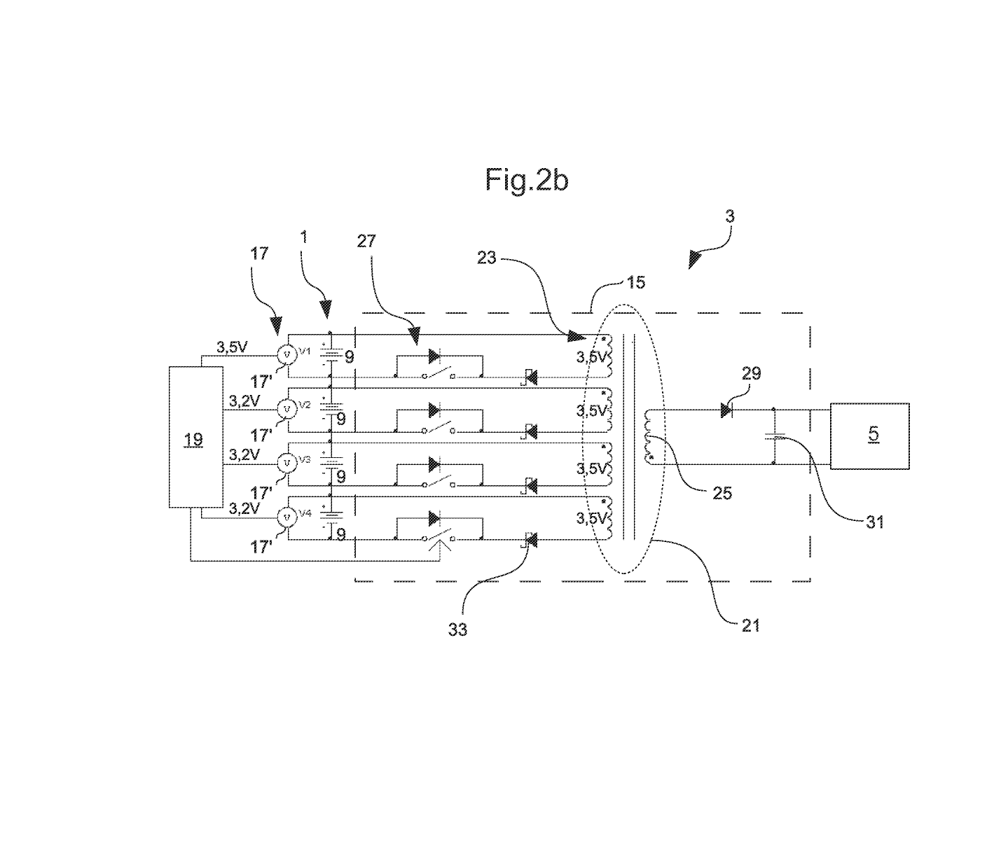

FIGS. 2a and 2b represent in greater detail the balancing system of FIG. 1,

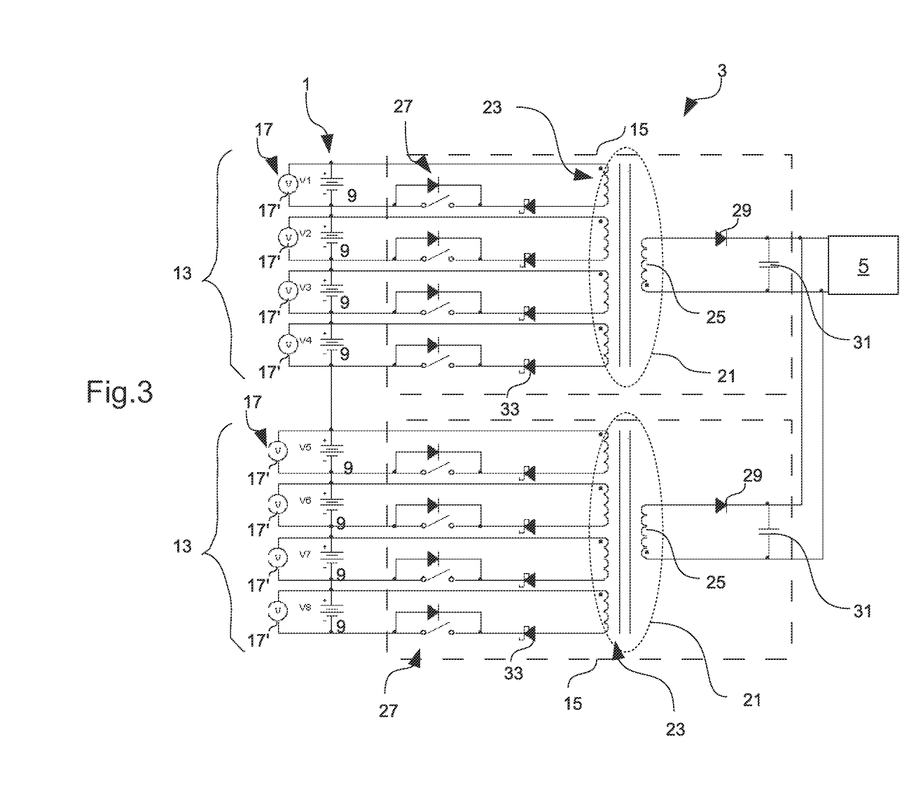

FIG. 3 represents a variant of the balancing system for a power battery comprising several modules of accumulator(s) stages in series,

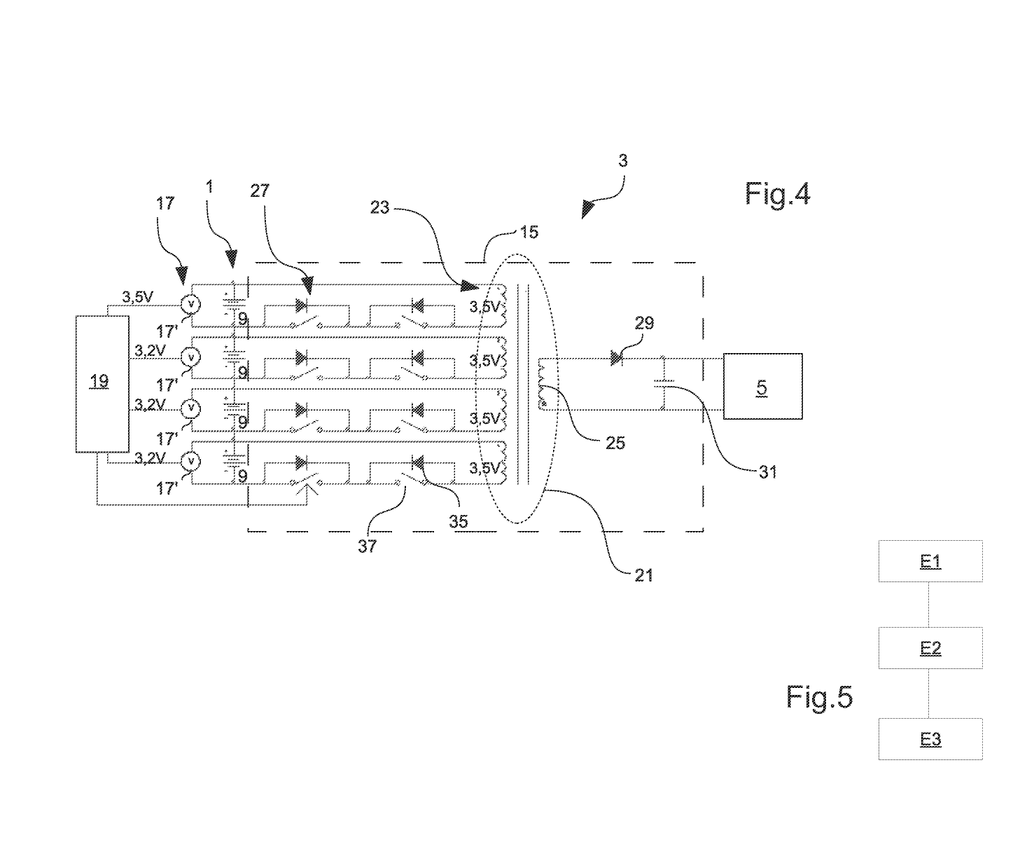

FIG. 4 represents a variant of the balancing system with synchronous rectification,

FIG. 5 illustrates in a schematic manner various steps of a charge balancing method for a power battery according to the first embodiment,

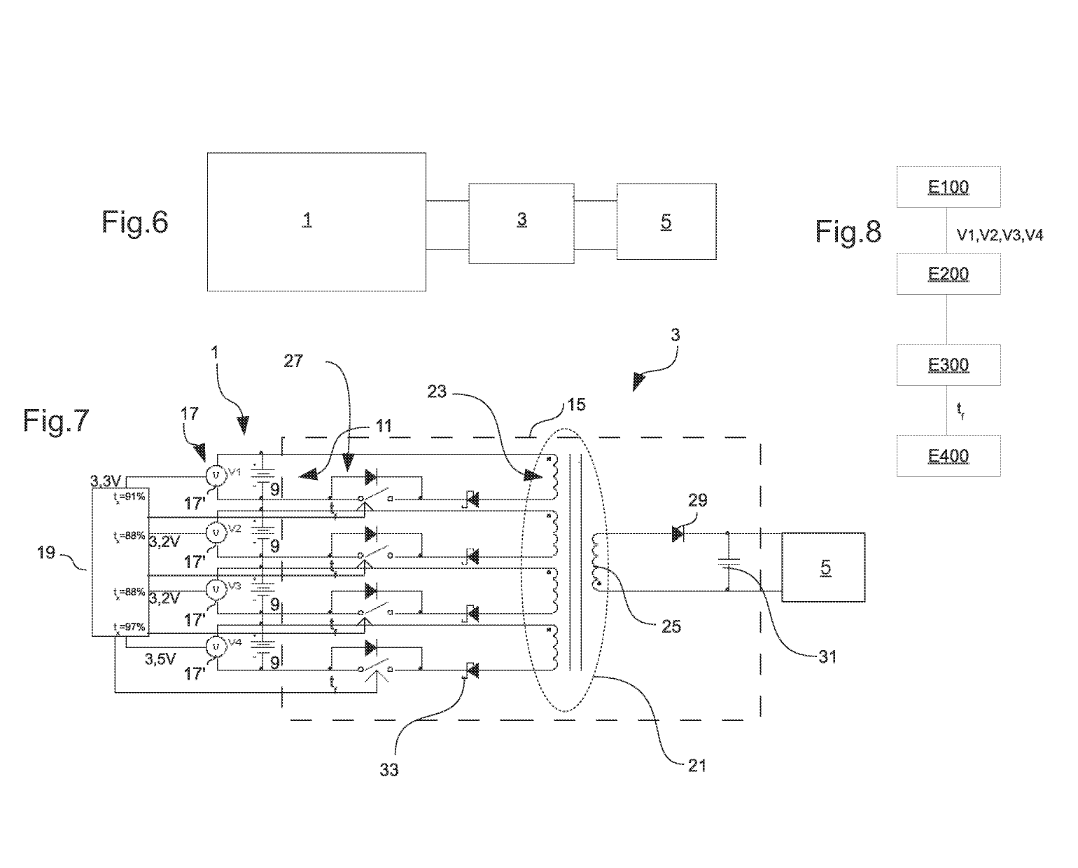

FIG. 6 represents in a schematic manner a second embodiment of the power battery balancing system allowing the energizing of an auxiliary battery,

FIG. 7 represents in greater detail the balancing system of FIG. 6,

FIG. 8 illustrates in a schematic manner various steps of a combined method of charge balancing of the power battery and of energizing of the auxiliary battery,

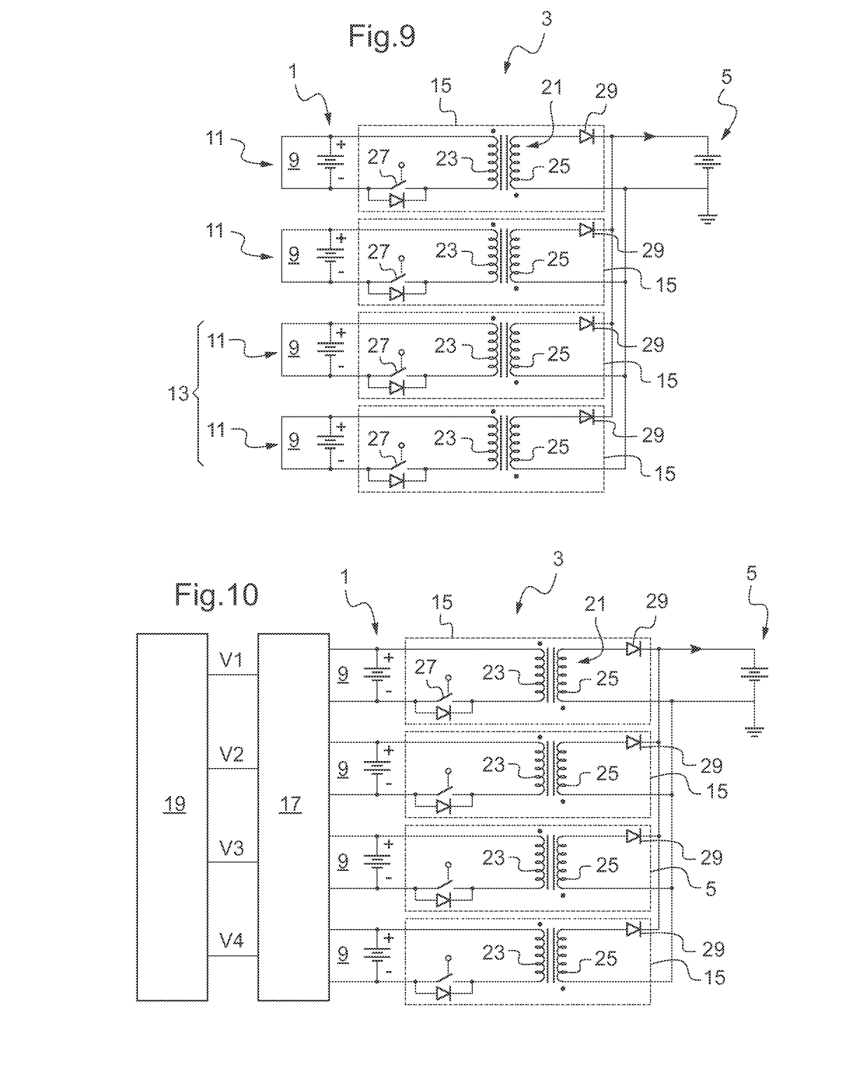

FIG. 9 represents in greater detail the power battery, an auxiliary battery and the balancing system according to a third embodiment,

FIG. 10 represents a monitoring device and a control device across the terminals of the power battery of FIG. 9,

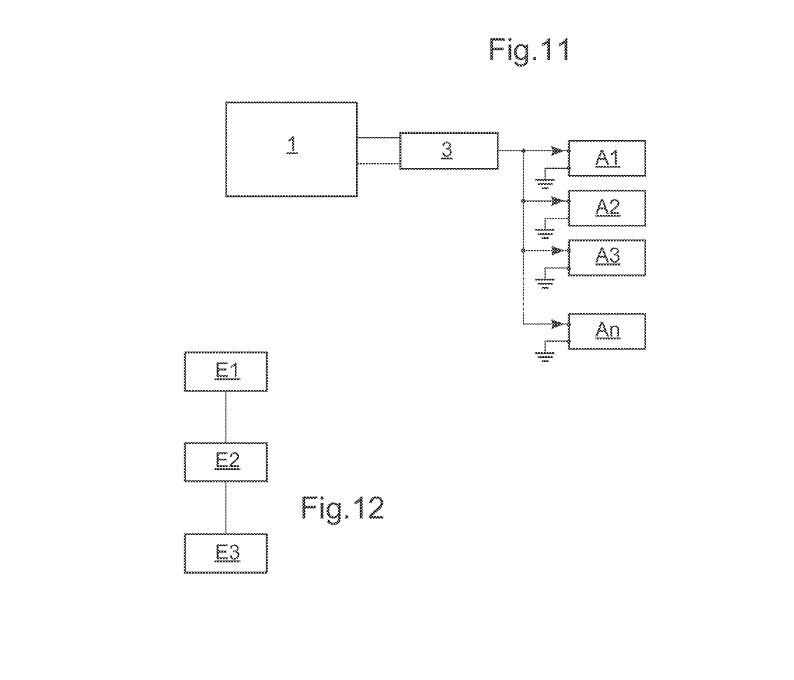

FIG. 11 represents in a schematic manner a fourth embodiment of the power battery balancing system allowing the energizing of the auxiliary battery, and

FIG. 12 illustrates in a schematic manner various steps of a charge balancing method for a power battery according to the third embodiment.

In these figures and in the subsequent description, the substantially identical elements are identified by the same reference numerals.

Represented in a schematic manner in FIG. 1 are:
a power battery 1 of high voltage of for example between 48V and 750V, for example for powering the motor of a hybrid or electric vehicle, and isolated from the chassis of the vehicle,
a balancing system 3 for the power battery 1,
an auxiliary battery 5 of lower voltage than that of the power battery 1, for example of 12V voltage, for powering for example the auxiliaries A1,A2 to An in the vehicle, and
a DC/DC converter 7 between the two batteries 1 and 5 to allow the energizing of the auxiliary battery 5 by the power battery 1 and effected with galvanic isolation to ensure the safety of the auxiliaries A1 to An.

The power battery 1 is a battery of accumulator(s) 9 (see FIGS. 2a,2b). This battery 1 can comprise several accumulators 9 arranged in series. This battery 1 can also comprise one or more additional accumulators arranged in parallel with the accumulators 9 in series so as to form accumulator(s) stages 11. Each stage 11 can therefore comprise an accumulator 9 or several accumulators in parallel.

As noted in FIG. 3, the battery 1 can comprise several modules 13 arranged in series, each module 13 comprising a predefined number of accumulator(s) stages 11. In the example illustrated, the battery 1 exhibits two modules 13 each having four accumulator(s) stages 11. With such a series association of modules 13, a defective module 13 can readily be replaced.

Of course, other configurations are possible with modules comprising for example eight, ten or else twelve stages 11 in series, and each stage 11 comprising two, four or even ten accumulators in parallel according to need.

Moreover, each module 13 can further be connected in parallel with another module 13.

### I.1 First Embodiment

A first embodiment of the balancing system 3 is now described. Referring again to FIGS. 2a,2b, it is noted that the balancing system 3 comprises:
a flyback converter 15 enclosed by dashes,
a monitoring device 17 for the voltage across the terminals of the stages 11 of accumulator(s) 9, and
a control device 19 for controlling the flyback converter 15 so as to balance the charge of the stages 11.

In the case where the battery 1 comprises several modules 13, the balancing system 3 can comprise a single flyback converter 15 for the battery 1 as a whole or several flyback converters 15 respectively associated with a module 13 as illustrated by FIG. 3. A defective flyback converter 15 can easily be replaced. In the case of a single flyback converter 15 for all the modules, balancing between the cells of one and the same module may be carried out by dissipation into resistors or any other system to limit the cost.

With reference to FIGS. 2a to 3, the flyback converter or converters 15 comprise respectively a transformer 21 surrounded by dots, with:
several primary windings 23 respectively associated with an accumulator(s) stage 11, and
a secondary winding 25 linked to the auxiliary battery 5.

A flyback converter 15 furthermore comprises on the side of each primary winding 23, a switch 27 embodied for example by a power transistor, for example a MOSFET and an antiparallel protection diode. This switch 27 is linked to the negative terminal (−) of the associated stage 11.

The flyback converter 15 also comprises on the side of the secondary winding 25 a diode 29 and a capacitor 31 in series.

Furthermore, a blocking diode 33, such as a Schottky diode, can make it possible to avoid energy transfer between the accumulator(s) stages 11. Moreover, the use of a Schottky diode makes it possible to limit the voltage drop on passing through the diode and also makes it possible to have a lower voltage threshold with respect to conventional diodes, for example of the order of 0.3V.

In order to improve the efficiency and to avoid losses in the Schottky diode 33, as a variant provision may be made to use synchronous rectification as illustrated in FIG. 4 by connecting in place of the Schottky diode 33 a diode 35 and a transistor 37 in parallel.

However, for example in the case of accumulators of Lithium-ion technology based on iron phosphate (LiFePO4), the voltage discrepancies are very low during charging: the voltages are generally around 3.2V. At the end of charging, these discrepancies increase to reach 0.5V at the maximum, the maximum charge voltage being 3.7V. The diode for protecting the transistor in the switch 27, has a voltage threshold of 0.7V, the discrepancy being 0.5V it prevents any discharging of a more charged stage to a less charged stage. It is then not necessary to arrange a Schottky diode or else to use synchronous rectification to ensure that an accumulator(s) stage does not discharge into a less charged accumulator(s) stage and that the energy is indeed transferred to the auxiliary battery.

At the end of discharging, it will be possible either to limit the minimum voltage to 2.7V to have a discrepancy of 0.5V with the plateau voltage of 3.2V, or to decide not to balance at this moment. This makes it possible to singularly increase the efficiency and to decrease the costs. This solution is valid for voltage discrepancies between accumulators not exceeding 0.6 to 0.7V during normal operation.

As regards the voltage monitoring device 17 for the accumulators 9, it comprises a means of measurement 17′ across the terminals of each stage 11. These measurement means 17′ are configured to transmit their measurement results to the control device 19.

The control device 19 comprises for its part at least one processing means for:
receiving the voltage measurements,
comparing the measured voltages, and
commanding the closure of the switches 27.

The stage 11 of higher voltage then imposes its voltage on the primary windings 23. The other stages 11 do not discharge on account of the presence of the Schottky diode 33. The energy of this stage 11 is therefore transferred via the transformer 21 to the auxiliary battery 5.

As a variant provision may be made to control the switches 27 individually. Thus, it is the switch 27 associated with the most charged stage 11 which is commanded to be closed.

An exemplary method of charge balancing for the accumulators 9 of the power battery 1 will now be described by referring to FIGS. 2b and 5.

During a first step E1, the voltage is measured across the terminals of the accumulator(s) stages 11. Each stage 11 exhibits a respective voltage V1,V2,V3,V4.

Let us take the example in which the voltage V1 is equal to 3.5V and the voltages V2,V3,V4 to 3.2V, the threshold voltage being for example 3.6V.

The means 17′ of measurement across the terminals of the first stage 11 therefore measures a voltage V1 of 3.5V, while the other measurement means 17′ measure respectively a voltage V2,V3,V4 of 3.2V.

The control device 19 compares the measured voltages in step E2.

The voltage V1 across the terminals of the first stage 11 is greater than the voltages V2 to V4 of the other stages 11. Consequently, the control device 19 commands the closure of the switches 27 in step E3. These switches 27 are controlled in a common manner and are therefore closed at the same time according to a predefined closure time.

The voltage V1 of 3.5V is imposed on the primary windings 23. This voltage V1 being greater than the voltages V2,V3,V4 of the other stages 11, the Schottky diodes for the stages 11 of respective voltage V2,V3,V4 are blocked thereby preventing the discharging of these stages 11. The primary windings 23 are therefore linked to the most charged stage 11 and this results in an increase in the magnetic flux in the transformer 21.

As a variant, only the switch 27 associated with the most charged stage 11 of voltage V1 is closed. This also results in an increase in the magnetic flux in the transformer 21 whose primary winding 23 is linked to this more charged stage 11.

Moreover, the voltage across the terminals of the secondary is negative thus blocking the diode 29.

When the switch or switches 27 open, the diode 29 becomes passing and also allows the rectification of the voltage which is thereafter filtered by the capacitor 31.

The charge of the accumulators 9 is then balanced by transferring the energy of the most charged stage 11 to the auxiliary battery 5.

This balancing can be done at any moment of operation of the vehicle, provided that consumption is observed on the auxiliary battery 5 or that it is possible to charge the auxiliary battery 5.

### I.2 Second Embodiment

A second embodiment is illustrated in a schematic manner in FIG. 6. This second embodiment differs from the first embodiment through the fact that the balancing system 3 completely replaces the DC/DC converter 7 of the first embodiment making it possible to energize the auxiliary battery 5 and ensuring galvanic isolation for the safety of the auxiliaries.

The costs of a DC/DC converter being eliminated, the balancing system may be larger and the balancing more powerful. In this case, the dimensioning of the hardware components of the balancing system 3 is adapted for such a transfer of energy from the power battery 1 to the auxiliary battery 5.

According to this second embodiment (FIG. 7), the control device 19 comprises at least one processing means for:
receiving the voltage measurements of the measurement means 17′,
comparing the measured voltages with a predefined threshold voltage,
determining a degree of charge t_{f} on the basis of the comparison results,
calculating a closure time t_{f} for each switch 27 as a function of the degree of charge tₓ of the associated stage 11, and
individually commanding the closure of the switches 27 according to the calculated closure times t_{f}.

An exemplary combined method of charge balancing for the accumulators 9 of the power battery 1 and of energizing of the auxiliary battery 5 will now be described with reference to FIGS. 7 and 8.

During a first step E100, the voltage is measured across the terminals of the accumulator(s) stages 11. Each stage 11 exhibits a respective voltage V1,V2,V3,V4. This voltage measurement can be done at a predefined instant such as the end of charging or at a moment of rest.

So as to simplify the example, we will consider that the voltage of the accumulator reflects its state of charge. This is not always the case but it makes it possible to more easily illustrate the matter. For LiFePO4 technology accumulators for example, the discrepancies in state of charge cannot be estimated on the basis of the voltage except at the end of charging and/or of discharging. Otherwise, the voltage differences between accumulators are often too low to be measured at reasonable cost.

Let us take the example in which the voltage V1 is equal to 3.3V, the voltages V2,V3 to 3.2V, and the voltage V4 to 3.5V, the threshold voltage being for example 3.6V.

The means 17′ of measurement across the terminals of the first stage 11 therefore measures a voltage V1 of 3.3V, while the second and third measurement means 17′ measure respectively a voltage V2,V3 of 3.2V, and the fourth measurement means 17′ measures a voltage V4 of 3.5V.

The control device 19 compares in step E200 each measured voltage with the threshold voltage of 3.6V so as to determine the degree of charge tₓ of each stage 11. A degree of charge of 91% is therefore determined for the first stage 11 of voltage V1 of 3.3V, a degree of charge of 88% for the second and third stages 11 of respective voltages V2,V3 of 3.2V, and a degree of charge of 97% for the last stage 11 of voltage V4 of 3.5V.

A closure time t_{f} of the associated switches 27 as a function of these degrees of charge tₓ of the stages 11 is then calculated in step E300. The closure time t_{f} of the switches 27 associated with the second and third stages 11 of voltage V2 and V3 will therefore be less than the closure time for the switch 27 associated with the first stage 11 of voltage V1, itself less than the closure time for the switch 27 associated with the last stage 11 of voltage V4.

According to a variant embodiment, instead of comparing the measured voltages with a threshold voltage in step E200, they are compared with each other so as to identify the most charged stages.

In the example given, the voltage V4 of 3.5V is greater than the voltage V1 of 3.3V, itself greater than the voltages V2,V3 of 3.2V (V4>V1>V2=V3). It follows from this that the stage 11 of voltage V4 is more charged than the stage 11 of voltage V1 which is more charged than the stages 11 of voltage V2 and V3.

According to this variant, a closure time for the associated switches is then calculated in step E300 as a function of these comparison results so as to bring about more discharge of the most charged stages 11. As previously, the closure time t_{f} for the switches 27 associated with the second and third stages 11 of voltage V2 and V3 will therefore be less than the closure time for the switch 27 associated with the first stage 11 of voltage V1, itself less than the closure time for the switch 27 associated with the last stage 11 of voltage V4.

Finally, in step E400, the intermittent closure of the switches 27 is commanded according to the closure times calculated so that the most charged accumulator(s) stages 11 are discharged more, until they attain substantially the same charge level as the least charged accumulator(s) stage 11.

In the example illustrated, the stages 11 of respective voltages V4 and V1 are discharged more in such a way that they attain substantially the same charge level of the less charged stages 11 of voltages V2 and V3.

As previously, this results in an increase in the magnetic flux in the transformer 21, and when the switches 27 open, the diode 29 becomes passing and also allows the rectification of the voltage which is thereafter filtered by the capacitor 31.

The auxiliary battery 5 is thus energized while balancing the charge of the stages 11 of accumulator(s) 9 by transferring the energy of the most charged stage 11 to the auxiliary battery 5.

Furthermore, in the case where the battery 1 comprises several modules 13, the powers provided by the balancing systems associated with these modules 13 add together to energize the auxiliary battery 5.

It is therefore understood that the energy transferred from the power battery 1 to the auxiliary battery 5 serves to balance the charge level of the accumulator(s) stages 11 of the power battery 1. Moreover, a single piece of electronics can carry out the two functions of charge balancing of the accumulators 9 of the power battery 1 and of energizing of the auxiliary battery 5.

### II.1 Third Embodiment

We now describe a third embodiment.

Referring to FIGS. 9 and 10, the balancing system 3 comprises for each accumulator(s) stage 11, a flyback converter 15 enclosed by dots, and a control device 19 for controlling the flyback converters 15 so as to balance the charge of the stages 11.

This third embodiment therefore differs from the first embodiment, in that the balancing system 3 exhibits a flyback converter 15 for each accumulator(s) stage 11 and not a converter 15 for a module 13 or for the battery 1 as a whole.

Thus, the balancing system 3 comprises a plurality of converters 15 mounted in parallel between the two batteries 1 and 5.

Each converter 15 is embodied with galvanic isolation to ensure the safety of the auxiliaries A1 to An.

A flyback converter 15 comprises a transformer 21, with a primary winding 23 associated with an accumulator(s) stage 11, and a secondary winding 25 linked to the auxiliary battery 5.

The association of a transformer 21 with a primary winding 23 and a secondary winding 25 per stage 11 rather than a transformer 21 for several stages 11, makes it possible to choose transformers 21 of lower power.

Provision may be made especially for transformers 21 according to on-printed-circuit planar technology. A transformer of planar type comprises a thin magnetic circuit generally made of machined ferrite, fixed on the printed circuit in which the turns are produced.

A flyback converter 15 furthermore comprises on the side of the primary winding 23, a switch 27 embodied for example by a power transistor, for example a MOSFET. This switch 27 is linked to the negative terminal (−) of the associated stage 11.

The flyback converter 15 also comprises on the side of the secondary winding 25 a diode 29 in series.

Each flyback converter 15 associated with a stage 11 is therefore independent of the other flyback converters 15; thereby allowing simultaneous operation of the converters 15 without interaction of one stage 11 on another stage 11.

### II.2 Fourth Embodiment

According to a fourth embodiment illustrated in a schematic manner in FIG. 11, the balancing system 3 completely replaces the DC/DC converter 7 of the first variant of the second embodiment making it possible to energize the auxiliary battery 5 and ensuring galvanic isolation for the safety of the auxiliaries A1 to An.

The power delivered by the balancing system 3 is sufficient to energize the auxiliary network termed the 12V network, or else low-voltage network, in the embodiment described.

Moreover, the redundancy of the plurality of flyback converters 15 also makes it possible to dispense with the auxiliary battery 5 in order to power the 12V network.

The costs of a DC/DC converter being eliminated, the balancing system may be larger and the balancing more powerful. In this case, the dimensioning of the components of the balancing system 3 is adapted for such a transfer of energy from the power battery 1 to the auxiliary battery 5.

The balancing system for the third or the fourth embodiment can also comprise a monitoring device 17 for the voltage across the terminals of the stages 11 of accumulator(s) 9.

This voltage monitoring device 17 for the accumulators 9 (FIG. 10), comprises for example a means of measurement across the terminals of each stage 11, configured to transmit their measurement results to the control device 19.

The control device 19 can control the switches 27 individually, so that the switch 27 associated with the most charged stage 11 is commanded to be closed.

The control device 19 can comprise moreover at least one processing means for receiving the voltage measurements of the monitoring device 17, analyze the measured voltages, and command the closure of one or more switches 27 as a function of the results of analyzing the measured voltages.

In order to analyze the measured voltages, the control device 19 can comprise a means for comparing the measured voltages with each other and a means for determining the most charged stages on the basis of the comparison results.

According to a variant, the control device 19 can comprise a means for calculating a product P for each stage 11 according to the following formula (1):

P=Crefi. (1−SOCi) (1)

(where Crefi=reference capacitance of a stage i, and SOCi=state of charge of the stage i)

Or as a variant, a means for calculating a product P′ for each stage 11 calculated according to a second formula (2):

P′=Crefi. SOCi (where Crefi=reference capacitance of a stage i, and SOCi=state of charge of the stage i). (2)

The capacitance corresponds to the electric charge that the accumulator can provide and is generally expressed in Ah or mAh. It is an intrinsic characteristic for each accumulator. This value can evolve slowly as a function especially of temperature, of aging, and decreases over the life of the accumulator. The information on the capacitance of each stage 11 may be the result of a learning in the course of the various cycles. The reference capacitance is generally given by the constructor, for example 60 Ah.

The control device 19 can furthermore comprise a means for determining the stage or stages 11 to be discharged so as to equalize the products P or P′ for each stage 11.

The control device 19 can comprise according to yet another variant:
a means for comparing the measured voltages with a threshold voltage,
a means for determining a degree of charge on the basis of the comparison results, and
a means for calculating a closure time for each switch 27 as a function of the degree of charge of the stage 11 determined.

The control device 19 can furthermore comprise at least one processing means for determining the power to be delivered by each stage 11 so as to energize the 12V network.

### II.3 Operation

Power Battery Charging Phase

We now describe, by referring to FIGS. 9 and 10, exemplary operation of the balancing system 3 of the third embodiment, in the case of the charging of a power battery 1, so as to bring all the stages 11 to a nominal voltage level.

This balancing can be done at the same time as the charging of the battery 1.

This balancing can be done at any moment of operation of the vehicle, provided that consumption is observed on the auxiliary battery 5 or that it is possible to charge the auxiliary battery 5.

If the consumption is insufficient on the 12V network, extra consumers may be turned on to increase the consumption on the 12V, such as the heating, the air-conditioning of the vehicle.

So as to simplify the example, we will consider that the voltage of the accumulator reflects its state of charge. This is not always the case but it makes it possible to more easily illustrate the matter. For LiFePO4 technology accumulators for example, the discrepancies in state of charge cannot be estimated on the basis of the voltage except at the end of charging and/or of discharging. Otherwise, the voltage differences between accumulators are often too low to be measured at reasonable cost.

First Variant

During a first step E201 (cf FIG. 12), the voltage is measured across the terminals of the accumulator(s) stages 11. Each stage 11 exhibits a respective voltage V1,V2,V3,V4.

Let us take the example in which the voltage V1 is equal to 3.3V, the voltages V2,V3 to 3.2V, and the voltage V4 to 3.5V, the threshold voltage being for example 3.6V.

The means of measurement across the terminals of the first stage 11 therefore measures a voltage V1 of 3.3V, the second and third measurement means respectively a voltage V2,V3 of 3.2V, and the fourth measurement means a voltage V4 of 3.5V.

This measurement can be done at any moment of operation of the vehicle, at regular intervals, or else at a predefined instant such as the end of charging or at a moment of rest of the vehicle.

The control device 19 can compare the measured voltages in step E202. The voltage V4 across the terminals of the fourth stage 11 is greater than the voltage V1 across the terminals of the first stage, itself greater than the respective voltages V2 and V3 of the second and third stages 11.

On the basis of this information, the control device 19 can determine, by comparing the measured voltages with each other, the most charged stages 11.

In the example, the voltage V4 of 3.5V is greater than the voltage V1 of 3.3V, itself greater than the voltages V2,V3 of 3.2V (V4>V1>V2=V3). It follows from this that the stage 11 of voltage V4 is more charged than the stage 11 of voltage V1 which is more charged than the stages 11 of voltage V2 and V3.

The control device 19 therefore determines on the basis of this information that the most charged stages 11 are the fourth and the first stage 11, and then commands in step E203 the closure of the associated switches 27.

This results in an increase in the magnetic flux in the transformer 21 whose primary winding 23 is linked to the fourth stage 11 and in the transformer 21 whose primary winding 23 is linked to the first stage 11.

The voltage across the terminals of the secondary 25 is negative thus blocking the diode 29.

When the switches 27 open, the diode 29 becomes passing.

The energy of the associated stage 11 is therefore transferred via the transformer 21 to the auxiliary battery 5.

The charge of the accumulators 9 is then balanced by transferring the energy of the most charged stage 11 to the 12V network.

Second Variant

Provision may also be made to discharge, each stage 11 as a function of the state of charge of the stage 11, for example so as to equalize the products P for each stage 11 according to the following formula (1):

P=Crefi. (1−SOCi) (1)

(where Crefi=reference capacitance of a stage i, and SOCi=state of charge of the stage i)

The product P increases in a manner inversely proportional to the state of charge; the more a stage 11 is charged the smaller the product P. Thus, the stages 11 whose products P are the lowest are discharged by priority.

It is possible to calculate in step E203 a closure time for the switches 27 as a function of these products P. The smaller the product P, therefore the more the stage is charged, and the longer the closure time, so as to discharge by priority the most charged stages 11.

And, the closure of the switches 27 is commanded according to the closure times calculated so as to equalize the products P.

Third Variant

It is possible as an alternative to determine a degree of charge for each stage and to deduce an appropriate closure time as a function of the determined degree of charge.

The degree of charge may be determined with respect to a threshold voltage, for example of 3.6V.

According to the example given, we thus determine:
for the first stage 11 of voltage V1 of 3.3V, a degree of charge of 91%,
for the second and third stages 11 of respective voltages V2,V3 of 3.2V a degree of charge of 88%, and
for the last stage 11 of voltage V4 of 3.5V a degree of charge of 97%.

A closure time for the switches 27 is then calculated in step E203 as a function of these degrees of charge.

The closure time for the switches 27 associated with the second and third stages 11 of voltage V2 and V3 will therefore be less than the closure time for the switch 27 associated with the first stage 11 of voltage V1, itself less than the closure time for the switch 27 associated with the last stage 11 of voltage V4.

Finally, the intermittent closure of the switches 27 is commanded according to the closure times calculated so as to bring about more discharging of the most charged accumulator(s) stages 11 until they attain substantially the same charge level as the least charged accumulator(s) stage 11.

In the example illustrated, the stages 11 of respective voltages V4 and V1 are discharged more in such a way that they attain substantially the same charge level of the less charged stages 11 of voltages V2 and V3.

As previously, this results in an increase in the magnetic flux in the transformer 21, and when the switches 27 open, the diode 29 becomes passing.

The 12V network is thus energized while balancing the charge of the stages 11 of accumulator(s) 9 by transferring the balancing energy from the stages 11 to the 12V network.

Of course, if following the balancing method, the stages 11 have not all reached the desired charge level, the charging of the stages 11 is continued, until a charge level of 100% is reached.

Power Battery Discharging Phase

We now describe an exemplary operation of the balancing system 3 following the discharging of the power battery 1.

The balancing can be done at the same time as the discharging of the battery 1. The most charged stages 11 are used by priority to energize the 12V low-voltage network.

To determine the most charged stages 11, the control device 19 can for example compare the products P′ for each stage 11 according to the following formula (2):

P′=Crefi. SOCi (where Crefi=reference capacitance of a stage i, and SOCi=state of charge of the stage i) (2)

In this case, the product P′ increases with the state of charge of each stage 11. Thus, the stages 11 whose products P′ are the highest are discharged by priority.

Of course, as a variant, the most charged stages 11 are determined by comparing the voltage levels measured in a manner similar to the first variant of the charging phase.

Or else according to another variant, the stages 11 the charged are determined by calculating a degree of charge by comparison with a threshold voltage, in a manner similar to the third variant of the charging phase.

The control device 19 can furthermore control the power delivered by each stage 11 to energize the 12V network.

For example, for the most charged stages 11, or those whose calculated products P′ are the highest, these stages 11 will deliver a maximum power Pm, for example of 20W.

For the other stages 11, the power Pi to be delivered may be calculated for example according to formula (3):

Pi(t)=P12(t)−Pm*x (with P12(t)=power consumed on the 12V network at a given instant t, Pm=maximum power delivered by the most charged stages 11, and x=integer part of the ratio P12 (t)/Pm) (3)

It is therefore understood that the energy transferred from the power battery 1 to the auxiliary battery 5 serves to balance the charge level of the accumulator(s) stages 11 of the power battery 1.

Moreover, a single piece of electronics can carry out the two functions of charge balancing of the accumulators 9 of the power battery 1 and of energizing of the auxiliary battery 5.

And, furthermore the use of several converters 15 in place of a single converter 15 makes it possible to have converters of lower power, with respect to a sole converter of the prior art, and which are therefore less expensive.

Furthermore, this redundancy of the converters 15 facilitates the elimination of the auxiliary battery 3 on account of the redundancy.

The balancing system 3 can furthermore ensure a function of providing the 12 volts accessory to the vehicle when the converters 15 pass sufficient power.

1-23. (canceled)

24. An apparatus comprising a charge-balancing system for a power battery, said charge-balancing system comprising at least two accumulator stages arranged in series, each accumulator stage comprising at least one accumulator, a flyback converter, said flyback converter comprising a transformer comprising at least one primary winding configured to be connected to terminals of an accumulator stage of said power battery, and a secondary winding configured to be connected to an auxiliary network whose voltage is less than that of said power battery, for each accumulator stage, an associated switch connected to said primary winding of said transformer and to a negative terminal of said accumulator stage, a monitoring device for monitoring voltage across terminals of said accumulator stages, and a control device for controlling said flyback converter, said control device comprising a processor configured for receiving voltage information from said monitoring device, and when an accumulator stage exhibits a voltage greater than that of other accumulator stages, causing closure of said switch associated with said accumulator stage and transfer of energy from said accumulator stage to said auxiliary battery so as to balance charge of said accumulator stages.

25. The apparatus of claim 24, wherein said charge-balancing system comprises a predefined number of flyback converters, each of which is associated with one of a predefined number of modules in series with said power battery, said modules comprising accumulator stages arranged in series.

26. The apparatus of claim 24, wherein said flyback converter is a common flyback converter connected to a predefined number of modules in series with said power battery, said modules comprising accumulator stages arranged in series.

27. The apparatus of claim 24, wherein said charge-balancing system further comprises a blocking diode for each accumulator stage, said blocking diode having an anode linked to said primary winding of said transformer and a cathode linked to said associated switch.

28. The apparatus of claim 27, wherein said blocking diode is a Schottky diode.

29. The apparatus of claim 24, wherein said charge-balancing system comprises, for each accumulator stage thereof, a diode and a transistor in parallel, said diode being linked by an anode thereof to said primary winding of said transformer and being linked by a cathode thereof to an associated switch of said accumulator stage.

30. The apparatus of claim 24, wherein said associated switches are configured to be controlled in a common manner by said control device so as to be closed at the same time when at least one of said accumulator stages exhibits a voltage greater than respective voltages of other accumulator stages.

31. The apparatus of claim 24, wherein each accumulator stage is connected at terminals thereof to an associated flyback converter, said associated flyback converter comprising a transformer comprising a primary winding configured to be connected to terminals of said associated accumulator stage, and a secondary winding configured to be connected to said auxiliary battery whose voltage is less than a voltage of said power battery, for each accumulator stage, an associated switch connected to a primary winding of said transformer and to a negative terminal of said accumulator stage, a monitoring device for monitoring voltage across terminals of said accumulator stages, and a control device for controlling said flyback converter, said control device comprising a processing element configured for receiving voltage information from said monitoring device, and when at least one accumulator stage exhibits a voltage greater than that of other accumulator stages, causing closure of at least one switch of a flyback converter associated with an accumulator stage, thereby causing transfer of energy from said accumulator stage to an auxiliary battery so as to balance charge across said accumulator stages.

32. The apparatus of claim 31, wherein said transformer is a planar technology transformer.

33. The apparatus of claim 31, wherein said charge-balancing system comprises a plurality of diodes respectively mounted in series with said transformers, each of said diodes being connected, by an anode thereof, to a secondary winding of a transformer and by a cathode thereof to said auxiliary battery.

34. The apparatus of claim 31, wherein each of said switches is individually controlled by said control device so as to cause closure of a switch associated with an accumulator stage having a voltage that is greater than respective voltages of other accumulator stages.

35. The apparatus of claim 34, wherein said control device comprises at least one processing element for calculating, for each accumulator stage, a closure time for a switch associated therewith, and causing closure of said switch during said closure time.

36. The apparatus of claim 31, wherein said flyback converter is dimensioned for a transfer of energy from said power battery to an auxiliary battery so as to energize said auxiliary battery.

37. The apparatus of claim 31, wherein said control device is configured to control said flyback converters so as to cause transfer of balancing energy from said accumulator stages to said auxiliary battery, and wherein said flyback converters exhibit galvanic isolation.

38. The apparatus of claim 31, wherein said control device is configured to control said flyback converters so as to energize said auxiliary battery on the basis of balancing energy for said power battery.

39. The apparatus of claim 38, wherein said control device comprises a processing element for determining power to be delivered by said accumulator stages.

40. The apparatus of claim 24, wherein said power battery is a Lithium-ion power battery.

41. The apparatus of claim 24, further comprising a motor vehicle disposed to receive motive power from said power battery.

42. The apparatus of claim 24, wherein said charge-balancing system is configured for charge balancing of accumulator stages of a power battery energizing a motor of an automotive vehicle, said automotive vehicle being selected from a group consisting of an electric vehicle and a hybrid vehicle.

43. A charge-balancing method for a power battery comprising at least two accumulator stages arranged in series, each accumulator stage comprising at least one accumulator, said method comprising measuring voltages across terminals of each accumulator stage, comparing said measured voltages, and in response to determining that one measured voltage is greater than other measured voltages, causing closure of at least one switch of a flyback converter, said flyback converter comprising a transformer that comprises at least one primary winding connected to terminals of an accumulator stage of said power battery and linked to said at least one switch, and a secondary winding connected to an auxiliary battery whose voltage is less than that of said power battery, whereby causing closure of said at least one switch effects transfer of energy from said accumulator stage associated with said at least one switch to said auxiliary battery, so as to balance charge of said accumulator stages.

44. The method of claim 43, further comprising, for each accumulator stage, calculating a closure time for said associated switch of said flyback converter, and causing closure of said switch during said calculated closure time.

45. The method of claim 44, further comprising, prior to calculating said closure time, measuring voltages across terminals of each accumulator stage of said power battery, comparing said measured voltages with a predefined threshold voltage, and determining a degree of charge of each accumulator stage based at least in part on results of said comparison, thereby enabling calculation of a closure time.

46. The method as claimed in claim 44, further comprising measuring voltage across terminals of each accumulator stage of said power battery, comparing said measured voltages with each other, and determining the most charged accumulator stage so as to calculate longer a closure time for said most charged accumulator stage.

47. The method as claimed in one of claim 43, wherein measuring voltages across terminals of each accumulator stage is carried out at a predefined instant.

48. The method as claimed in one of claim 43, wherein measuring voltages across terminals of each accumulator stage is carried at the end of charging said power battery.
